(19) United States
(12) Patent Application Publication
(10) Pub. No.: US 2001/0030010 A1
(43) Pub. Date: Oct. 18, 2001

(54) Fibers melt-spun from a thermoplastic alternating copolymer and a process for preparing such fibers

(76) Inventors: Johannes Anthonij Juijn, Velp (NL); Adriaan Jacobus De Vries, Velp (NL)

Correspondence Address: OLIFF & BERRIDGE, PLC, P.O. Box 19928, Alexandria, VA, 22320, US

(21) Appl. No.: 09/780,385

(22) Filed: Feb. 12, 2001

Related U.S. Application Data
(63) Continuation-in-part of application No. PCT/EP99/05475, filed on Jul. 26, 1999.

(30) Foreign Application Priority Data
Aug. 11, 1998 (NL) 1009840

(51) Int. Cl. B60C 9/00; C08G 67/02; D01D 5/16; D02G 3/48

(52) U.S. Cl. 152/451; 264/210.8; 428/364; 528/392

(57) ABSTRACT

Fibers melt-spun from a thermoplastic alternating copolymer composed of alkenes and carbon monoxide have a

tenacity BT>900 mN/tex,

melting point Tm>220° C.,

crystallinity Vc>33%, and

birefringence Δn>0.0550.

These fibers are prepared by melt-spinning the copolymer and then drawing the resulting fibers, the spinning process being conducted using a polymer melt free of crystallization nuclei at a temperature of at most 40 K above the melting temperature of the polymer Tₘ(in K) and the drawing of the fibers being conducted at a temperature in the range of T_{mc}−15 K to T_{mc}−90 K, with T_{mc} representing the constrained melting temperature, at a draw ratio in the range of 5 to 12 and a drawing tension corrected for temperature DT_{d.corr.} in the range of 105 to 300 mN/tex. The fibers are pre-eminently suitable for use as reinforcing yarn in rubber articles such as car tires.

### BACKGROUND OF THE INVENTION

The invention pertains to fibers melt-spun from a thermoplastic alternating copolymer composed of alkenes and carbon monoxide, to a process for preparing such fibers, in which process the copolymer is melt-spun and the resulting fibers are subsequently drawn, as well as to rubber articles such as tires incorporating such fibers.

Melt-spun fibers of the aforesaid type are known from EP-B-0 310 171. According to the process described in said document, a thermoplastic alternating copolymer composed of an olefinically unsaturated compound and carbon monoxide is spun from the melt at a temperature of at least Tₘ+20° C., and the fibers are then drawn at a temperature of at most Tₘ−10°C., with Tₘ representing the crystalline melting point of the polymer.

Said patent publication offers no instructions whatsoever regarding the drawing tensions to be applied during the drawing process in order to obtain fibers of the listed breaking tenacity. In addition, the level of the spinning temperature of 560 K (287° C.) used in the examples makes it clear that the polymer has been seriously affected by thermal degradation. This results in a large number of problems such as an unstable spinning performance, the risk of yarn rupture, discoloration of the polymer, a wide variation in the properties of the formed fibers, and a marked deterioration of their mechanical properties.

All that has been said about the process described in EP-B-0 310 171 is equally true, mutatis mutandis, for the brief descriptions of the melt-spinning processes in the Japanese patent publications listed below: JP-A-09-323011, JP-A-09-323384, JP-A-09-324355, JP-A-09-324377, JP-A-09-328342, and JP-A-09-329198. No information whatsoever is provided regarding the drawing tensions applied during the drawing process. Moreover, the employed spinning temperature of 275° C. is much too high to prevent degradation of the polymer, so also for that reason the quality of the obtained fibers is unsatisfactory.

### SUMMARY OF THE INVENTION

The invention now provides fibers melt-spun on a commercial scale from a thermoplastic alternating copolymer composed of alkenes and carbon monoxide, which differ from the known melt-spun fibers of the same composition through constant quality, high tenacity, high crystallinity, and high birefringence.

The alternating copolymer composed of alkenes and carbon monoxide of which the melt-spun fibers are made generally has an intrinsic viscosity in m-cresol at 25° C. of at least 0.3 dl/g. The melt-spun fibers according to the invention have a tenacity BT of more than 900 mN/tex and are further characterized by a melting point Tₘ, determined using the DSC method, >220° C., a crystallinity V_{c}>33%, and a birefringence Δn>0.0550. Melt-spun fibers according to the invention having a tenacity BT>1000 mN/tex are characterized by a melting point Tₘ, determined using the DSC method, >220° C., a crystallinity V_{c}>35%, and a birefringence Δn>0.0570.

According to the invention, fibers melt-spun from an alternating copolymer composed of ethylene/propylene and carbon monoxide with a propylene content between 4 and 0.5 mole %, calculated on ethylene, and a tenacity BT>1000 mN/tex are characterized by a melting point determined using the DSC method>240° C., a crystallinity V_{c}>40%, and a birefringence Δn >0.0570.

The invention also consists of a process of the known type mentioned in the opening paragraph by which melt-spun fibers of high tenacity can be obtained when in the spinning process use is made of a polymer melt free of crystallization nuclei at a temperature of at most 40 K above the melting temperature of the polymer Tₘ(in K) and the drawing of the fibers takes place at a temperature in the range of T_{mc}−15 K to T_{mc}−90 K, with T_{mc} representing the “constrained” melting temperature, at a draw ratio in the range of 5 to 12 and a drawing tension corrected for temperature DT_{d.corr.} in the range of 105 to 300 mN/tex,

$${DT}_{d , corr} = \frac{{F}_{DR} \cdot DR}{{tex [ {ⅇ}^{( 1000 / {T}_{d} )} - {ⅇ}^{( 1000 / {T}_{mc} )} ]}^{0.8}}$$

wherein F_{DR} represents the force measured at a draw ratio DR (in mN) and T_{d} represents the drawing temperature (in K), the calculation of the drawing tension corrected for temperature including a linear density of the fibers prior to starting of the drawing.

### DETAILED DESCRIPTION OF PREFERRED EMBODIMENTS

Surprisingly, it has been found that when the right combination of drawing temperature and drawing tension is applied, the fibers obtained are of exceptionally high and constant quality and high tenacity.

According to the invention, preference is given to a process where the draw ratio employed is more than 7 at a drawing tension in the range of 120 to 280 mN/tex.

The fibers obtained when using the process according to the invention generally have a tenacity in the range of 313 In(DT_{d,corr)-}575 to 313 In(DT_{d,corr)-}755.

It was found that when the process according to the invention is used, fibers having a breaking tenacity in excess of about 900 mN/tex can be obtained when use is made of a drawing tension corrected for temperature DT_{d,corr.} of more than 140 mN/tex.

According to the invention, the term fibers refers to staple fibers as well as short fibers, filaments, and yarns (an assembly of filaments).

By alternating copolymers composed of alkenes and carbon monoxide are meant, according to the invention, polymers built up from alkene and carbon monoxide units in alternating sequence. This means that in the polymer chain each carbon monoxide unit will have two alkene units as its immediate neighbors, and vice versa.

In the process according to the invention, in the preparation of fibers with properties rendering these fibers pre-eminently suitable for technical application, i.e., fibers of high breaking tenacity and high modulus, preferably use is made of a polymer where 80-100% of the alkene units is composed of ethylene and 20-0% is composed of propylene. Optimal results were obtained when use was made of an alternating copolymer composed of ethylene/propylene and carbon monoxide and with a propylene content between 4 and 0.5 mole %, calculated on ethylene. The preparation of alternating copolymers composed of alkenes and carbon monoxide is described, int. al., in EP-A-121 965, EP-A-222 454, EP-A-224 304, EP-A-227 135, EP-A-228 733, EP-A-229 408, EP-A-235 865, EP-A-235 866, EP-A-239 145, EP-A-245 893, EP-A-246 674, EP-A-246 683, EP-A-248 483, EP-A-253 416, EP-A-254 343, EP-A-257 663, EP-A-259 914, EP-A-262 745, EP-A-263 564, EP-A-264 159, EP-A-272 728, and EP-A-277 695.

In order to improve the polymer's resistance to thermal degradation, adjuvants counteracting said degradation can be added to the polymer. Examples of such adjuvants are inorganic acid binding compounds such as calcium hydroxyapatite or alumina, polymer stabilisers such as sterically hindered phenols, carbodiimides, epoxy compounds, and phosphites, or combinations thereof.

In melt-spinning alternating copolymers composed of alkenes and carbon monoxide, use may be made of equipment also known to be used for melt-spinning other thermoplastic polymers. For instance, in the extrusion of the polymer, use may be made of a spinneret plate such as is employed in melt-spinning other polymers such as polyethylene terephthalate. Such a spinneret plate has a number of capillaries having a diameter of 200 to 2000 μm and an L/D ratio of 1 to 10.

Highly advantageous results are obtained when the spinneret plate is connected up with a heated tube the temperature of which at most equals the spinning temperature (Tₛₚᵢₙ). Preferably, a heated tube with a temperature between Tₛₚᵢₙ−50° C. and Tₛₚᵢₙ is employed.

After spinning the resulting fibers can be wound prior to being drawn. In that case preference is given to a process in which the fibers are drawn immediately following on from the spinning process.

The resulting fibers are pre-eminently suitable for use as reinforcing yarn in tires on account of the favorable combination of high breaking tenacity and modulus, good adhesion to rubber, and high fatigue resistance. Also, the fibers are highly suitable for reinforcing other rubber articles such as conveyor belts and V-belts. In addition, the fibers are highly suitable for use in technical fabrics, e.g., such as are used in paper making, where high standards with regard to resistance to hydrolysis are imposed.

Measuring methods

Intrinsic viscosity [η]

[η] is determined using the equation:

[η]=lim_{c}_{^{→0}}η_{spec}/c=lim_{c}_{^{→0}}(t−t₀)/t₀_{^{.}}c

and so stands for the ratio between the flow times t and t₀, with t₀ representing the flow time of the solvent and t representing the flow time of the polymer-containing solution in a capillary viscometer at 298 K (25° C.). c in this determination stands for the polymer concentration in m-cresol, expressed in grams per deciliter.

The intrinsic viscosity of the polyketone employed generally is in the range of 0.5 to 5 dl/g, preference being given to an intrinsic viscosity of 1.2-4.5 dl/g, more particularly of 1.2-2.5 dl/g.

In order to characterize the structure of the melt-spun yarns according to the invention, a two-phase model was adopted in which separate crystalline and amorphous domains can be discerned. Structural characterization was carried out by combining the results of X-ray diffraction, density measurements, birefringence, and differential scanning calorimetry.

X-ray diffraction (XRD)

AXS measurements were carried out in transmission on samples prepared by winding a smooth layer of yarn filaments around a metal frame. The vertical diffractometer (Philips) was equipped with a quartz monochromator, Soller slits, a divergence slit (1°), a scatter slit (0.2 mm), a receiving slit (1°), and a sealed gas filled detector PW1711/10. The X-ray source was a CuKα tube with λ=1.5418 Å. The diffractometer was coupled to a computer for collecting the data. The X-ray scans were fitted by means of Pearson VII functions.

Density

The density of the samples was determined at 23° C. in a Davenport gradient column containing toluene and tetrachloromethane mixed in a ratio that gradually decreased downwards. The density measurements were carried out on three pieces of yarn. After 12 hours the density was calculated from their positions in the column.

Birefringence

Twenty filaments immersed in dibutyl phthalate were positioned parallel to each other between microscopic glasses and placed at an angle of 45° relative to the crossed polarizers of an optical microscope, which was equipped with a sodium lamp (λ=0.5893 μm) and a Sénarmont compensator. At the ends of the filaments, which were cut on the bias, the overall phase difference φ was determined by measuring the number of fringes (including partial fringes). For each filament the birefringence was calculated from Δn=(φ/2π)*(λ/D), with D representing the diameter of the filament.

Melting point Tₘ

The crystalline melting point Tₘ of the polymer was determined with Differential Scanning Calorimetry (DSC).

The melting peaks of the yarn were determined with a Perkin Elmer DSC-7 by heating the sample (3-4 mg) in a cup at a rate of 20° C./min and recording the heat flow difference between the sample cup and an empty reference cup.

T_{mc}, the constrained melting temperature, was determined in a manner analogous to that for Tₘ using Differential Scanning Calorimetry, with the proviso that this time instead of a sample of an isotropic polymer a yarn wound tightly around a metal strip was employed.

T_{NF}, the temperature at which the polymer is free of crystallization nuclei (T_{NF}) was determined as follows:

3-4 mg of polymer were introduced into 10 μl aluminium cups provided with lids with holes punched into them. The cups were put into a Perkin Elmer DSC-7 Robotic system and then subjected to the following temperature program:

heating to T_{hold} at a heating-up rate of 10° C./min, with T_{hold}≧Tₘ (the crystalline melting point of the polymer),

keeping at a constant temperature of T_{hold} for t minutes, and

cooling down to room temperature at a cooling rate of 10° C./min, with T_{hold} being varied from Tₘ to Tₘ +50 and with there preferably being 1-3 minutes of keeping at a constant temperature.

Both the peak temperature of the recrystallization (T_{rc}) and the onset of the recrystallization (T_{rco}) can be derived from the cooling curve.

The value of T_{rc} or T_{rco} measured over one and the same period of keeping at a constant temperature is then plotted against T_{hold}. On the axis on which T_{hold} is plotted T_{NF} can be read from the point of inflection in the curve found.

Specific information on the crystalline part of the yarn was obtained from XRD measurements. Because of its polymorphic nature, the copolymer, hereinafter PK, can crystallize into two possible conformations, called PK-α and PK-β. Although PK-β is the more likely structure, both possibilities were taken into consideration.

The total amount of crystalline volume, Vc, was calculated as

$${V}_{c} = \frac{D - {D}_{a}}{{D}_{c} - {D}_{a}}$$

wherein D is the (measured) overall density, Dₐ represents the amorphous density (for which a value of 1221 kg/m³ was taken), and D_{c} is the total crystalline density, defined as:

D_{c}=V_{α}*D_{c, α}+(1−V_{α})*D_{c,β}•

In this formula Vα represents the (volume) percentage of crystalline material that is in the α-structure. This factor is determined directly from the quotient of areas of the respective (210) peaks in the XRD equator scan (after fitting), according to:

$${V}_{α} = \frac{{A}_{α ( 210 )}}{{A}_{a ( 210 )} + {A}_{β ( 210 )}}$$

D_{c, α} and D_{c,β} are the respective crystalline densities of the α- and β-structures. They can be calculated directly from the molar mass and the dimensions of the unit cell in the orthorhombic structure. These unit cell parameters \vec{a}, \vec{b}, and \vec{c} are determined from the positions of the XRD (hkl) peaks after fitting, according to the following table:

| | a axis | b axis | c axis |
|---|---|---|---|
| α-structure | (200) | (210) and (200) | (002) |
| β-structure | (210) and (200) | (210) and (310) | (002) |

Tenacity:

The tenacity (BT) as defined in ASTM D2256-88, published in April 1988, is obtained from the force-elongation curve and the measured filament tex. To determine the force-elongation curve, a single filament or a multifilament yarn is stretched to rupture on an Instron tensile tester. The length between grips for the single ruptured filament is 10 cm. The results for 3 filaments are averaged. All samples were stretched at a constant rate of elongation of 10 mm/min.

The filament tex is calculated on the basis of the functional resonant frequency (ASTM D1577-66, Vol. 25, 1968) or by means of measurement by microscope.

The tenacity is expressed in mN/tex and was measured on fibers conditioned at 20° C. and 65% relative humidity for at least 24 hours.

The invention will be further illustrated with reference to the following examples. Of course, the scope of the invention is not restricted to the specific details of the examples.

### EXAMPLE I

An alternating copolymer of ethylene/propylene and carbon monoxide having a propylene content of 7 mole % calculated on ethylene, a melting point of 225° C. (determined using the DSC method), and an [η]=1.5 was melted in an extruder equipped with five heating zones. The temperature/residence time profile to be passed through was as follows: 248° C., 245° C., 245° C., 248° C., and 248° C. The overall residence time was 114 sec at a throughput of 92 g/minute.

From the extruder the polymer was passed via a conveying pipe and a spinning pump to the spinning assembly including the spinneret plate. The temperature of the conveying pipe, the spinning pump, and the spinning assembly was 250° C. After an average residence time of 43 sec at said temperature the polymer was spun through a spinneret plate having 36 orifices each of 400 μm. Underneath the spinneret plate there was a 40 cm long hot tube with a wall temperature of 250° C. and beneath that a cooling zone of 80 cm in length into which under a pressure of 125 N/m² cooled air of 20° C. was introduced. The resulting as-spun yarn was wound at a rate of 400 m/min.

### EXAMPLE II

The as-spun yarn of Example I, having a linear density of 230 tex f36, was subjected to a number of drawing treatments. The drawing devices used for this had a length of 42 cm (hot plate) and 2 m (steamdrawing frame), respectively. The starting velocity in each case was 6 m/minute. The draw ratios were in the range of 4 to 10, while the temperatures at which drawing took place ranged from 150 to 220° C.

The results of the drawing treatments and the values measured during these treatments for the draw ratio, the drawing device employed, the drawing temperature, the linear density of the feed yarn, the drawing tension DT_{d}, and the drawing tension corrected for temperature DT_{d,corr.} are all listed in the table below. In it DT_{d}=F_{DR}.DR/tex stands for the drawing tension, and DT_{d,corr.} for the corresponding drawing tension corrected for temperature according to the formula shown above. The constrained melting temperature, measured by DSC, of the yarns drawn to the highest degree was 240° C.

Of the sixteen yarn samples drawn, samples 1 and 15 failed to meet the criterion of the invention that the drawing tension should exceed 105 mN/tex. Note that in sample 15 use was made of a drawing temperature close to the unconstrained melting temperature. This makes the drawing operation more critical.

TABLE 1

| | | | | | drawing | | | | | |
|---|---|---|---|---|---|---|---|---|---|---|
| | | | drawing | drawing | tension | | | | | |
| | | drawing | force | tension | DT_{d,corr} | draw | tenacity | | | |
| yarn | drawing | temp. T_{d} | F_{DR} | DT_{d} | in | ratio | in | Tₘ° | | V_{c,} |
| sample | device | in ° C. | in cN | in mN/tex | mN/tex | DR | mN/tex | C | Δn | % |
| 1* | steam | 150 | 423 | 73 | 26 | 4 | 394 | | | |
| 2 | steam | 150 | 1200 | 334 | 120 | 6.4 | 868 | | | |
| 3 | steam | 175 | 1050 | 329 | 169 | 7.2 | 974 | | | |
| 4 | hot | 175 | 1053 | 312 | 160 | 6.8 | 906 | | | |
| | plate | | | | | | | | | |
| 5 | hot | 175 | 841 | 227 | 117 | 6.2 | 841 | | | |
| | plate | | | | | | | | | |
| 6 | steam | 205 | 580 | 188 | 177 | 7.5 | 1020 | 222 | 0.0572 | 36 |
| 7 | steam | 205 | 650 | 222 | 209 | 7.9 | 1070 | 225 | 0.0590 | 37 |
| 8 | steam | 205 | 700 | 246 | 231 | 8.1 | 1109 | 225 | 0.0595 | 39 |
| 9 | steam | 205 | 730 | 262 | 247 | 8.3 | 1084 | 224 | 0.0597 | 40 |
| 10 | steam | 205 | 755 | 277 | 261 | 8.5 | 1113 | 226 | 0.0603 | 39 |
| 11 | steam | 205 | 780 | 296 | 279 | 8.7 | 1178 | 226 | 0.0611 | 40 |
| 12 | steam | 200 | 750 | 261 | 217 | 8 | 1068 | | | |
| 13 | steam | 210 | 642 | 223 | 242 | 8 | 1056 | | | |
| 14 | steam | 215 | 567 | 197 | 252 | 8 | 1020 | | | |
| 15* | steam | 220 | 257 | 67 | 104 | 6 | 565 | | | |
| 16 | steam | 220 | 498 | 173 | 269 | 8 | 978 | | | |

The data listed in the table above clearly shows that when a wing tension corrected for temperature of less than 105 mN/tex is employed, fibers obtained have a tenacity which is too low for a wide range of commercial scale applications. It was also found that fibers having the highest city are obtained when using a draw ratio of more than 7.

### EXAMPLE III

An alternating copolymer of ethylene/propylene and carbon monoxide having a propylene content of 3 mole %, calculated on ethylene, a ting point of 236° C. (determined using the DSC method), and an [η]=1.53 melted in an extruder equipped with five heating zones. The temperature/residence time profile to be passed through was as follows: 270° C., 265° C., 265° C., 265° C., and 265° C. The overall residence time was 114 sec at a throughput of 92 g/minute.

From the extruder the polymer was passed via a conveying pipe and a spinning pump to the spinning assembly including the spinneret plate. The temperature of the conveying pipe, the spinning pump, and the spinning assembly was 265° C. After an average residence time of 43 sec at said temperature the polymer was spun through a spinneret plate having 36 orifices each of 400 μm. Underneath the spinneret plate there was a 50 cm long hot tube with a wall temperature of 265° C. and beneath that a cooling zone of 80 cm in length into which under a pressure of 125 N/m² cooled air of 20° C. was introduced. The resulting as-spun yarn was wound at a rate of 400 m/min.

### EXAMPLE IV

The as-spun yarn of Example III, having a linear density of 230 tex f36, was drawn in a steam box of 2 m in length. The starting velocity in each case was 6 m/minute. The draw ratios were in the range of 6.5 to 8.25, the temperature of the steam in each case was 215° C.

The results of the drawing treatments and the values measured during these treatments for the draw ratio, drawing temperature, linear density of the feed yarn, drawing tension DT_{d}, and drawing tension corrected for temperature DT_{d,corr.} are all listed in Table 2. In it DT_{d}=F_{DR}.DR/tex stands for the drawing tension, and DT_{d,corr.} for the corresponding drawing tension corrected for temperature according to the formula shown above. The constrained melting temperature, measured by DSC, of the yarns drawn to the highest degree was 255° C. For that reason in the formula a value Tₘ=255° C. was employed.

All yarn samples 11 through 15 satisfied the criterion of the invention that the drawing tension DT_{d,corr.} should exceed 105 mN/tex.

TABLE 2

| | | | | | drawing | | | | | |
|---|---|---|---|---|---|---|---|---|---|---|
| | | | drawing | drawing | tension | | | | | |
| | | drawing | force | tension | DT_{d,corr} | draw | tenacity | | | |
| yarn | drawing | temp. T_{d} | F_{DR} | DT_{d} | in | ratio | in | Tₘ° | | V_{c,} |
| sample | device | in ° C. | in cN | in mN/tex | mN/tex | DR | mN/tex | C | Δn | % |
| 17 | team | 215 | 464 | 131 | 120 | 6.5 | 875 | 243 | 0.0547 | 41 |
| 18 | team | 215 | 543 | 165 | 151 | 7.0 | 934 | 244 | 0.0564 | 41 |
| 19 | team | 215 | 638 | 208 | 191 | 7.5 | 997 | 245 | 0.0582 | 43 |
| 20 | team | 215 | 713 | 248 | 227 | 8.0 | 1094 | 246 | 0.0590 | 44 |
| 21 | team | 215 | 753 | 270 | 247 | 8.25 | 1158 | 246 | 0.0594 | 45 |

The data listed in the table above shows that fibers having a high tenacity are obtained when the draw ratio exceeds 7.5.

What we claims is:

1. Fibers melt-spun from a thermoplastic alternating copolymer composed of alkenes and carbon monoxide having a
tenacity BT>900 mN/tex,
melting point Tm>220° C.,
crystallinity Vc>33%, and
birefringence Δn>0.0550.

2. Fibers melt-spun from a thermoplastic alternating copolymer composed of alkenes and carbon monoxide having a
tenacity BT>1000 mN/tex,
melting point Tm>220° C.,
crystallinity Vc>35%, and
birefringence Δn>0.0570.

3. Fibers melt-spun from a thermoplastic alternating copolymer composed of ethylene/propylene and carbon monoxide and with a propylene content between 4 and 0.5 mole %, calculated on ethylene, having a
tenacity BT>1000 mN/tex,
melting point Tm>240° C.,
crystallinity Vc>40%, and
birefringence Δn>0.0570.

4. A process for preparing fibers from a thermoplastic alternating copolymer composed of alkenes and carbon monoxide, in which the process comprises melt-spinning the copolymer and subsequently drawing the resulting fibers, wherein the melt-spinning process is conducted with a polymer melt free of crystallization nuclei at a temperature of at most 40 K above the melting temperature of the polymer Tₘ (in K) and the drawing of the fibers is conducted at a temperature in the range of T_{mc}−15 K to T_{mc}−90 K, with T_{mc} representing the constrained melting temperature, at a draw ratio in the range of 5 to 12 and a drawing tension corrected for temperature DT_{d,corr.} in the range of 105 to 300 mN/tex,
$${DT}_{d , corr} = \frac{{F}_{DR} \cdot DR}{{tex [ {ⅇ}^{( 1000 / {T}_{d} )} - {ⅇ}^{( 1000 / {T}_{mc} )} ]}^{0.8}}$$
wherein F_{DR} represents the force measured at a draw ratio DR (in mN) and T_{d} represents the drawing temperature (in K), the calculation of the drawing tension corrected for temperature including a linear density of the fibers prior to starting of the drawing.

5. A process according to claim 4, wherein the draw ratio is at least 7 and the drawing tension corrected for temperature is in the range of 120 to 280 mN/tex.

6. A process according to claim 4, wherein the fibers obtained following the process have a tenacity (in mN/tex) in the range of 313In(DT_{d,corr.})−575 to 313In(DT_{d,corr.})−755.

7. A process according to claim 4, wherein the drawing tension corrected for temperature DT_{d,corr.} is more than 140 mN/tex, and wherein the fibers obtained following the process have a tenacity of more than about 900 mN/tex.

8. A process according to claim 4, wherein the alternating copolymer contains ethylene.

9. A process according to claim 8, wherein in the alternating copolymer, 80 to 100% of the alkene units are composed of ethylene.

10. A process according to claim 4, wherein the alternating copolymer is composed of ethylene/propylene and carbon monoxide and with a propylene content between 4 and 0.5 mole %, calculated on ethylene.

11. A rubber article containing the fibers according to claim 1.

12. A tire containing the fibers according to claim 1.

13. The tire according to claim 12, wherein the tire is a car tire.

14. A tire containing the fibers made according to the process of claim 4.

15. A rubber article containing the fibers made according to the process of claim 4.
